(19) United States
(12) Patent Application Publication
(10) Pub. No.: US 2010/0179825 A1
(43) Pub. Date: Jul. 15, 2010

(54) COPYING PATIENT-CUSTOMIZED HEALTHCARE PLANS/ORDERS/PHASES

(75) Inventors: YEGOR FARIDOVICH HANOV, Overland Park, KS (US); FRAN PIVONKA, Lenexa, KS (US); KIM INCE, Raymore, MO (US)

Correspondence Address: SHOOK, HARDY & BACON L.L.P.;(Cerner Corporation), Intellectual Property Department, 2555 GRAND BOULEVARD, KANSAS CITY, MO, 64108-2613, US

(73) Assignee: CERNER INNOVATION, INC., Overland Park, KS (US)

(21) Appl. No.: 12/684,465

(22) Filed: Jan. 8, 2010

Related U.S. Application Data
(60) Provisional application No. 61/143,644, filed on Jan. 9, 2009.

(51) Int. Cl. G06Q 50/00

(52) U.S. Cl. 705/2

(57) ABSTRACT

Computerized methods in a clinical computing environment for presenting previously customized, patient-specific healthcare plans, orders, phases and/or portions thereof, in association with subsequent patient encounters are provided. The method includes receiving a patient identifier associated with a patient and a particular encounter; receiving an indicator of a condition/diagnosis associated with the patient and the particular encounter; determining that the patient has presented with the condition/diagnosis in association with at least one previous encounter; and presenting at least one order, healthcare plan, phase of a healthcare plan, or portion thereof associated with the at least one previous encounter, wherein the presented at least one order, healthcare plan, phase of a healthcare plan, or portion thereof includes at least one patient-specific customization.

### CROSS-REFERENCE TO RELATED APPLICATIONS

This application claims the benefit under 35 U.S.C. §119(e) of Provisional Patent Application No. 61/143,644, filed Jan. 9, 2009, which provisional application is hereby incorporated by reference as if set forth in its entirety herein.

### STATEMENT REGARDING FEDERALLY SPONSORED RESEARCH OR DEVELOPMENT

Not applicable.

### BACKGROUND

Healthcare orders are requests placed by healthcare providers for, e.g., procedures, medications, laboratory tests, evaluations, treatments, and nursing tasks to be done for a patient. A healthcare plan includes multiple orders for treatment for a particular problem or ailment. For example, a healthcare plan for a cancer patient may include multiple medication orders, laboratory testing orders and orders for diagnostic tests. Often times, an order (or set of orders) will set forth a healthcare plan having components which span multiple phases. For instance, a healthcare plan for a chemotherapy protocol may specify that a particular medication is to be given in a specified dosage on three separate days, e.g., Day 1, Day 8, and Day 15. In this instance, each day may be viewed as a separate phase. Phases, however, are not limited to units of time. In simple terms, a phase is merely a plan within a plan and, accordingly, may be a unit of time, a diagnostic grouping, or any other sub-plan within a healthcare plan.

Within the ambulatory setting, there are instances where an order, a plan of care, or a phase of a plan of care is repeated across multiple encounters for a particular patient. For instance, a renal dialysis patient may receive the same set of orders (associated with one another in a healthcare plan) repeatedly on multiple different encounters. Generally, however, a healthcare plan and the orders and/or phases within the healthcare plan are discontinued when the patient is discharged and, thus, the encounter is terminated. As healthcare plans, orders and phases are selected from reference (that is, from templates representing routine treatment for particular conditions/diagnoses and void of any patient-specific customizations), the next time the patient presents with the same condition/diagnosis, the clinician must again search for and select the appropriate healthcare plan, order, or phase from a laundry list of possible appropriate treatment options. Further, if any customizations are made to an order, phase or healthcare plan associated with a patient on a particular encounter, these customizations must again be made in association with each subsequent encounter for which the same healthcare plan, order, or phase is desired.

### BRIEF SUMMARY

Embodiments of the present invention relate to methods in a clinical computing environment for copying an order, a healthcare plan, a phase of a healthcare plan, or a portion thereof, that is associated with a first encounter for a patient and includes at least one patient-specific customization, upon the patient presenting on a second encounter having the same condition/diagnosis. In accordance with embodiments hereof, a patient presents at a hospital, clinic or other healthcare facility with a particular condition or diagnosis. It is then determined if the patient has previously presented with the same condition/diagnosis in association with a previous encounter. If the patient has not previously presented with the same condition/diagnosis, a clinician searches for and selects an appropriate healthcare plan, order and/or phase from a plurality of reference plans/orders/phases; customizes the selected healthcare plan, order and/or phase (that is, adds an order, removes an order, changes an order detail, calculates a medication dose, or the like); and orders the customized plan/order/phase for the patient. If, however, it is determined that the patient has previously presented with the same condition/diagnosis, the clinician is presented with a list of healthcare plans, orders and/or phases that have been previously ordered and customized for the patient. The clinician may select an appropriate plan/order/phase from the presented listing and the selected plan/order/phase will include the customizations previously made for the patient. In this way, the clinician can save time in ordering plans of care as they do not have to make the same customizations every time they want to order the same plan of care/order/phase for a particular patient.

In one embodiment, the present invention is directed to one or more computer-readable storage media having computer-executable instructions embodied thereon that, when executed, perform a method in a clinical computing environment for presenting previously customized, patient-specific healthcare plans, orders, phases and/or portions thereof, in association with subsequent patient encounters. The method comprises receiving an indicator of at least one of a condition or a diagnosis associated with a patient and a particular encounter; determining that the patient has presented with the at least one of the condition or the diagnosis in association with at least one previous encounter; and presenting at least one order, healthcare plan, healthcare plan phase, or portion thereof associated with the at least one previous encounter, wherein the presented at least one order, healthcare plan, healthcare plan phase, or portion thereof includes at least one customization specific to the patient.

In another embodiment, the present invention is directed to one or more computer-readable storage media having computer-executable instructions embodied thereon that, when executed, perform a method in a clinical computing environment for presenting previously customized, patient-specific healthcare plans, orders, healthcare plan phases, and/or portions thereof, in association with subsequent patient encounters. The method comprises receiving a first indicator of at least one of a symptom, a condition or a diagnosis associated with a patient and a particular encounter, the particular encounter being associated with a facility; determining that the patient has not previously presented with the at least one of the symptom, the condition, or the diagnosis at the facility or a related facility; presenting at least one reference order, healthcare plan, healthcare plan phase, or portion thereof that is related to the at least one of the symptom, the condition, or the diagnosis; receiving at least one customization to a selected one of the at least one reference order, healthcare plan, healthcare plan phase, or portion thereof, the at least one customization being specific to the patient, to create a customized order, healthcare plan, healthcare plan phase, or portion thereof; and storing the customized order, healthcare plan, healthcare plan phase, or portion thereof in association with the patient. The method further comprises receiving a second indicator of the at least one of the symptom, the condition, or the diagnosis associated with the patient and a subsequent encounter, the subsequent encounter being associated with the facility or a facility related thereto; and presenting the customized order, healthcare plan, healthcare plan phase, or portion thereof.

In still another embodiment, the present invention is directed to one or more computer-readable storage media having computer-executable instructions embodied thereon that, when executed, cause display of a user interface that presents previously customized, patient-specific healthcare plans, orders, healthcare plan phases, and/or portions thereof, in association with subsequent patient encounters. The user interface comprises a content display area that displays previously customized, patient-specific healthcare plans, orders, healthcare plan phases, and/or portions thereof that have been customized for a particular patient in association with a previous encounter, such display occurring upon the particular patient presenting in association with a subsequent encounter at a facility associated with the previous encounter or a facility related thereto with at least one of a symptom, a condition, or a diagnosis related to the previous encounter. The user interface further comprises a selectable copy indicator, selection of which permits a particular displayed and previously customized, patient-specific healthcare plan, order, healthcare plan phase, and/or portion thereof to be ordered for the particular patient in association with the subsequent encounter. In embodiments, the user interface also comprises a filtering criteria display area that displays at least one filtering criterion on which the displayed and previously customized, patient-specific healthcare plans, orders, healthcare plan phases, and/or portions thereof may be filtered.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing environment suitable for use in implementing the present invention;

FIGS. 2A-2E are a flow diagram showing a method in accordance with an embodiment of the present invention for copying an order, a healthcare plan, a phase of a healthcare plan, or a portion thereof, that is associated with a first encounter for a patient and includes at least one patient-specific customization, upon the patient presenting on a second encounter having the same condition/diagnosis;

FIG. 3 is a screen display of an exemplary view illustrating a manner in which a user may view plans that have been ordered for a patient in association with at least one prior encounter upon the patient presenting in association with a subsequent encounter, in accordance with an embodiment of the present invention;

FIG. 4 is a screen display of an exemplary view illustrating a manner in which a user may filter plans that have been ordered for a patient in association with at least one prior encounter based upon condition/diagnosis, in accordance with an embodiment of the present invention;

FIG. 5 is a screen display of an exemplary view illustrating that a healthcare plan has been copied, including the customizations made in association with the prior encounter, in accordance with an embodiment of the present invention;

FIG. 6 is a screen display of an exemplary view illustrating a healthcare plan that has been ordered for a patient and includes at least one customization made prior to ordering, in accordance with an embodiment of the present invention; and

FIG. 7 is a screen display of an exemplary view illustrating a manner in which a user may copy the selected phase of the healthcare plan, including the customizations, in association with the same encounter, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention relate to methods in a clinical computing environment for copying an order, a healthcare plan, a phase of a healthcare plan, or a portion thereof, that is associated with a first encounter for a patient and includes at least one patient-specific customization, upon the patient presenting on a second encounter having the same condition/diagnosis. In accordance with embodiments hereof, a patient presents at a hospital, clinic or other healthcare facility with a particular condition or diagnosis. It is then determined if the patient has previously presented with the same condition/diagnosis in association with a previous encounter. If the patient has not previously presented with the same condition/diagnosis, a clinician searches for and selects an appropriate healthcare plan, order and/or phase from a plurality of reference plans/orders/phases; customizes the selected healthcare plan, order and/or phase (that is, adds an order, removes an order, changes an order detail, calculates a medication dose, or the like); and orders the customized plan/order/phase for the patient. If, however, it is determined that the patient has previously presented with the same condition/diagnosis, the clinician is presented with a list of healthcare plans, orders and/or phases that have been previously ordered and customized for the patient. The clinician may select an appropriate plan/order/phase from the presented listing and the selected plan/order/phase will include the customizations previously made for the patient. In this way, the clinician can save time in ordering plans of care as they do not have to make the same customizations every time they want to order the same plan of care/order/phase for a particular patient.

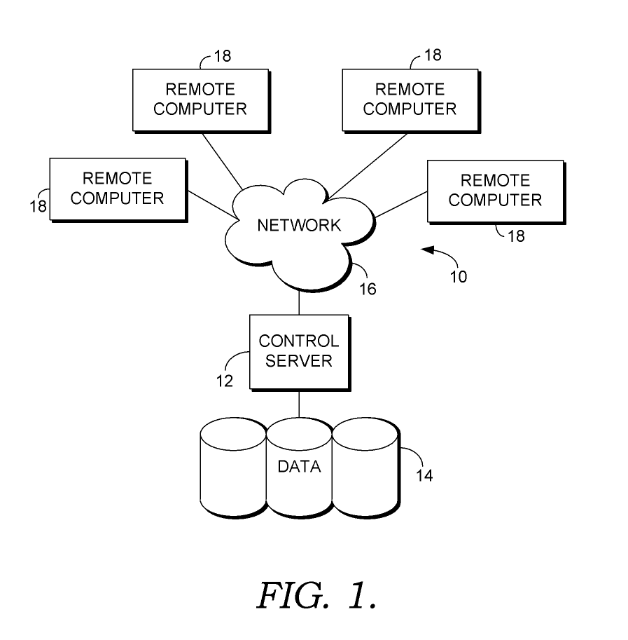

Referring to the drawings in general, and initially to FIG. 1 in particular, an exemplary computing system environment, for instance, a medical information computing system, on which embodiments of the present invention may be implemented is illustrated and designated generally as reference numeral 10. It will be understood and appreciated by those of ordinary skill in the art that the illustrated medical information computing system environment 10 is merely an example of one suitable computing environment and is not intended to suggest any limitation as to the scope of use or functionality of the invention. Neither should the medical information computing system environment 10 be interpreted as having any dependency or requirement relating to any single component or combination of components illustrated therein.

Embodiments of the present invention may be operational with numerous other general purpose or special purpose computing system environments or configurations. Examples of well-known computing systems, environments, and/or configurations that may be suitable for use with embodiments of the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

Embodiments of the present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 10 includes a general purpose computing device in the form of a control server 12. Components of the control server 12 may include, without limitation, a processing unit, internal system memory, and a suitable system bus for coupling various system components, including database cluster 14, with the control server 12. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 12 typically includes, or has access to, a variety of computer-readable media, for instance, database cluster 14. Computer-readable media can be any available media that may be accessed by the control server 12, and includes volatile and nonvolatile media, as well as removable and non-removable media. By way of example, and not limitation, computer-readable media may include computer-readable storage media and communication media. Computer-readable storage media may include, without limitation, volatile and nonvolatile media, as well as removable and nonremovable media implemented in any method or technology for storage of information, such as computer-readable instructions, data structures, program modules, or other data. In this regard, computer-readable storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the control server 12. Communication media typically embodies computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The computer-readable storage media discussed above and illustrated in FIG. 1, including database cluster 14, provide storage of computer-readable instructions, data structures, program modules, and other data for the control server 12.

The control server 12 may operate in a computer network 16 using logical connections to one or more remote computers 18. Remote computers 18 may be located at a variety of locations in a medical or research environment, for example, but not limited to, clinical laboratories, hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 18 may also be physically located in non-traditional medical care environments so that the entire health care community may be capable of integration on the network. The remote computers 18 may be personal computers, servers, routers, network PCs, peer devices, other common network nodes, or the like, and may include some or all of the components described above in relation to the control server 12. The devices can be personal digital assistants or other like devices.

Exemplary computer networks 16 may include, without limitation, local area networks (LANs) and/or wide area networks (WANs). Such networking environments are commonplace in offices, enterprise-wide computer networks, intranets, and the Internet. When utilized in a WAN networking environment, the control server 12 may include a modem or other means for establishing communications over the WAN, such as the Internet. In a networked environment, program modules or portions thereof may be stored in the control server 12, in the database cluster 14, or on any of the remote computers 18. For example, and not by way of limitation, various application programs may reside on the memory associated with any one or more of the remote computers 18. It will be appreciated by those of ordinary skill in the art that the network connections shown are exemplary and other means of establishing a communications link between the computers (e.g., control server 12 and remote computers 18) may be utilized.

In operation, a user may enter commands and information into the control server 12 or convey the commands and information to the control server 12 via one or more of the remote computers 18 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the control server 12. In addition to a monitor, the control server 12 and/or remote computers 18 may include other peripheral output devices, such as speakers and a printer.

Although many other internal components of the control server 12 and the remote computers 18 are not shown, those of ordinary skill in the art will appreciate that such components and their interconnection are well known. Accordingly, additional details concerning the internal construction of the control server 12 and the remote computers 18 are not further disclosed herein.

Although methods and systems of embodiments of the present invention are described as being implemented in a WINDOWS operating system, operating in conjunction with an Internet-based system, one of ordinary skill in the art will recognize that the described methods and systems can be implemented in any system supporting the receipt and processing of healthcare orders. As contemplated by the language above, the methods and systems of embodiments of the present invention may also be implemented on a stand-alone desktop, personal computer, or any other computing device used in a healthcare environment or any of a number of other locations.

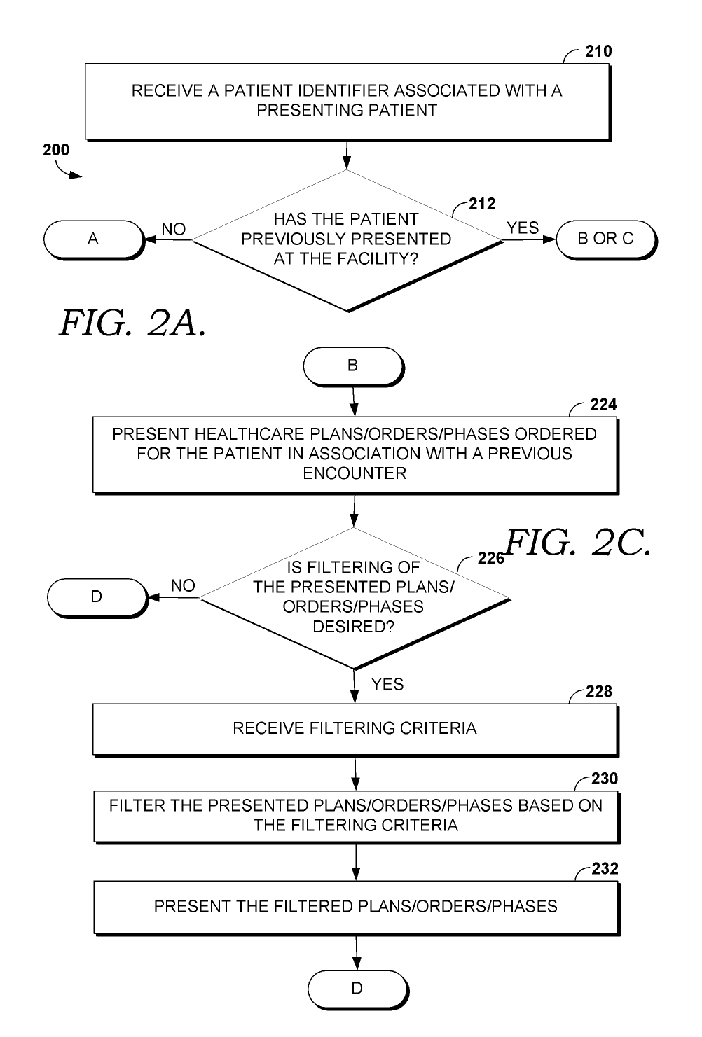

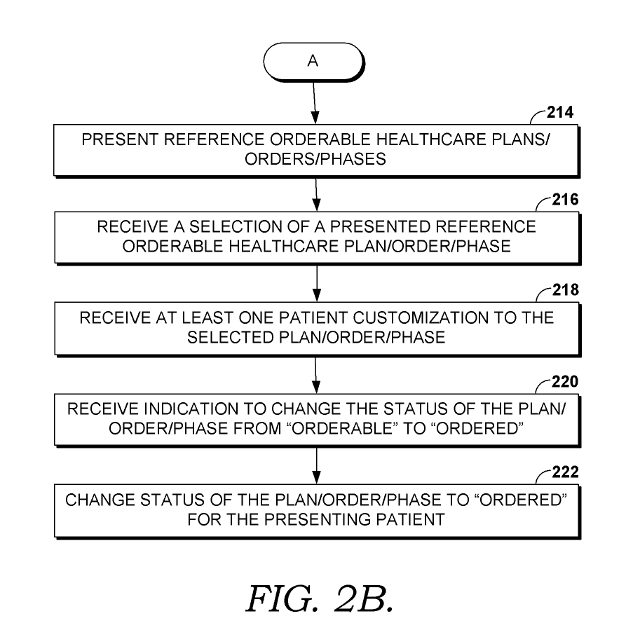

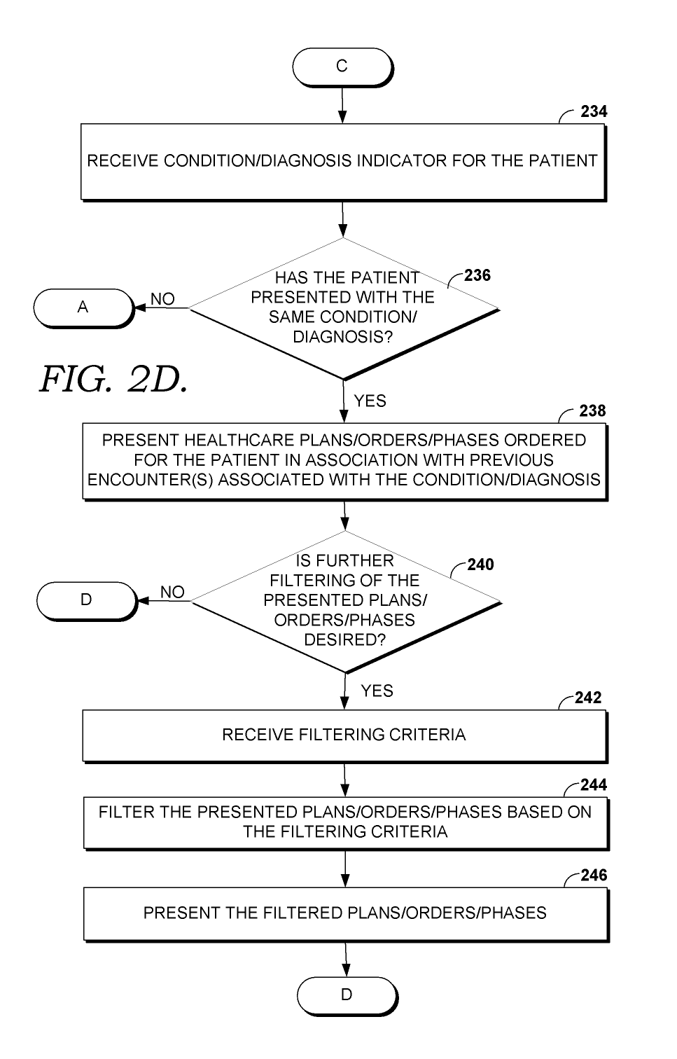

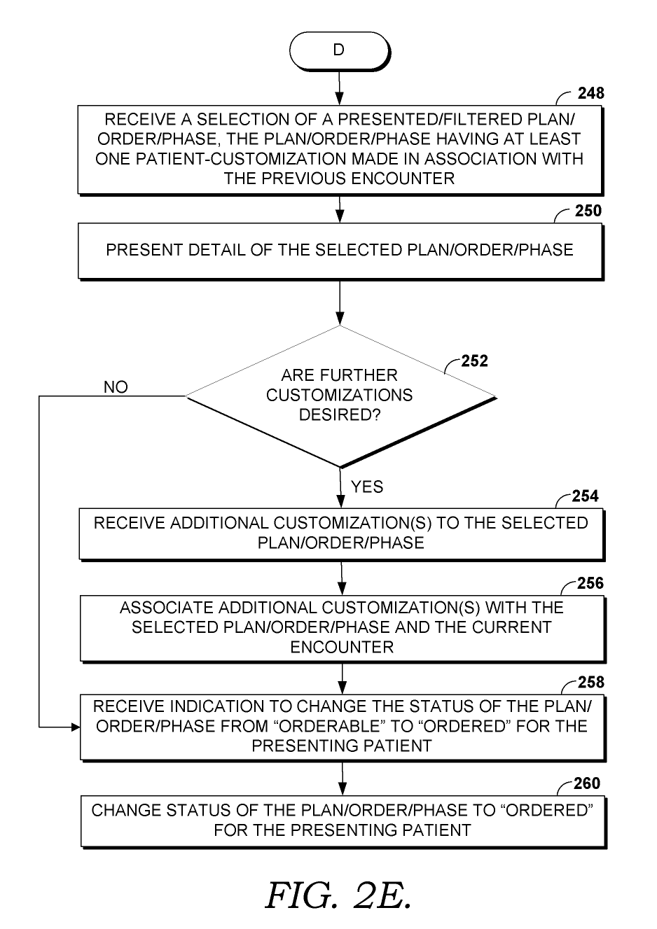

As previously mentioned, in one embodiment, the present invention relates to a computerized method and system for use in, e.g., a healthcare computing environment, for copying a healthcare plan, order, phase, or portion thereof, that is associated with a first encounter for a patient and includes at least one patient-specific customization, upon the patient presenting on a second encounter having the same condition/diagnosis. With reference to FIGS. 2A-2E, a flow chart representative of such a method in accordance with an embodiment of the present invention is illustrated and depicted generally as reference numeral 200. Method 200 may be implemented on the above-described exemplary computing system environment (FIG. 1) and, by way of example only, may be utilized to present to a clinician, at least one previously ordered and patient-customized healthcare plan, order, phase, or portion thereof, upon the patient presenting in association with a subsequent encounter. (The terms “individual”, “person”, and “patient” are used interchangeably herein and are not meant to limit the nature of the referenced individual in any way. Rather, the methods and systems described herein are equally applicable in, for instance, a veterinary setting. Further, use herein of the term “patient” is not meant to imply any particular relationship between the individual and those modifying component(s) of a clinical order.)

Initially, as shown at block 210 (FIG. 2A), a patient identifier associated with a presenting patient is received. The patient identifier may be, for instance, a medical identification number associated with the patient, the patient's social security number, or the like. As shown at block 212, it is next determined whether or not the patient has previously presented at the receiving facility or a related facility (that is, another facility sharing access to the same electronic medical documentation). If it is determined that the patient has not previously presented at the receiving facility or a related facility, a plurality of reference healthcare plans/orders/phases (or identifiers thereof, such as a title) is presented. This is indicated at block 214 of FIG. 2B. Reference healthcare plans/orders/phases are essentially templates representing routine treatment for particular conditions/diagnoses and are void of any patient-specific customizations. Each reference healthcare plan/order/phase has a status of ‘orderable’ indicating that it is capable of being ordered in association with the presenting patient. In one embodiment (not shown), a presenting condition and/or diagnosis may be received prior to presenting the reference healthcare plans/orders/phases (or identifiers thereof), the presented healthcare plans/orders/phases being only those that are appropriate for a received condition/diagnosis. In another embodiment, categories of healthcare plans/orders/phases may be initially presented with the actual healthcare plans/orders/phases (or identifiers thereof) being presented subsequent to a selection of a particular category. Any and all such variations, and any combination thereof, are contemplated to be within the scope of embodiments of the present invention.

With continued reference to FIG. 2B, a selection of one of the presented reference orderable healthcare plans/orders/phases is then received, as indicated at block 216. Generally, although not required, at least one patient-customization will be received to the selected reference healthcare plan/order/phase, as indicated at block 218. Patient customizations may be, for instance, the addition of an order to a healthcare plan or phase, the exclusion of an order from a healthcare plan or phase, a medication dosage calculation (generally based on patient-specific parameters such as weight), and detail changes to an order (whether or not associated with a healthcare plan or phase). As indicated at block 220, an indication is received to change the status of the selected (and customized, if applicable) healthcare plan/order/phase from ‘orderable’ to ‘ordered’ in association with the presenting patient and the current encounter. The status of the healthcare plan/order/phase is subsequently changed to ‘ordered’ for the presenting patient, as indicated at block 222, and accordingly stored in association with an electronic medical record associated with the presenting patient, e.g., an electronic medical record generated by Cerner Millennium available from Cerner Corporation of North Kansas City Mo.

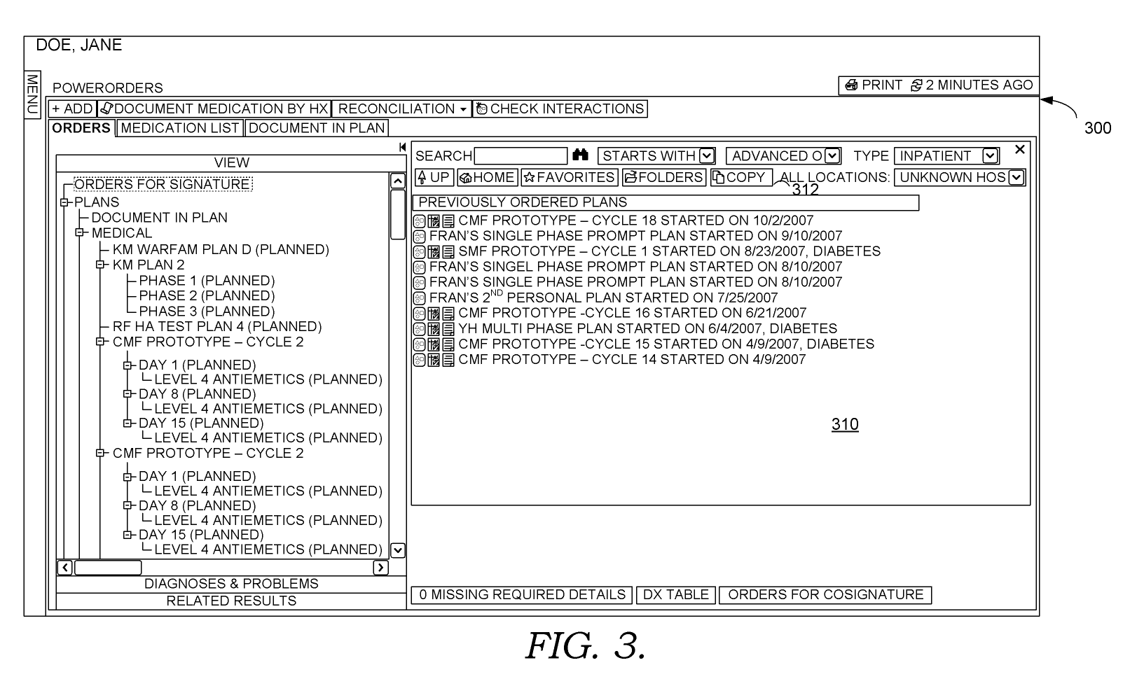

Referring back to FIG. 2A, if it is determined at block 212 that the patient has previously presented at the facility or a related facility, the method may take one of two potential pathways. In a first pathway, illustrated with reference to FIG. 2C, any healthcare plans/orders/phases ordered for the presenting patient in association with a previous encounter at the facility or a related facility are presented, as indicated at block 224. FIG. 3 illustrates an exemplary view 300 showing a manner in which a user may view such plans/orders/phases that have been ordered for a patient in association with at least one prior encounter upon the patient presenting in association with a subsequent encounter. The view 300 includes a content display area 310 that displays previously customized, patient-specific healthcare plans, orders, healthcare plan phases, and/or portions thereof that have been customized for a particular patient in association with a previous encounter. The view 300 also includes a selectable copy indicator 312, selection of which permits a particular displayed and previously customized, patient-specific healthcare plan, order, healthcare plan phase, and/or portion thereof to be ordered for the particular patient in association with the subsequent encounter.

Such previously ordered healthcare plans/orders/phases generally include any patient-customizations input in association with the encounter(s) to which the plans/orders/phases correspond. However, if subsequent to ordering the healthcare plan/order/phase in association with the corresponding previous encounter(s), something did not go as planned with the patient and/or the patient-customized plan was not completed as ordered, one or more of the previously ordered patient-customizations may not be carried forward when the plan is selected in association with a subsequent encounter. In such a situation, the previously patient-customized plan/order/phase, or portion thereof, may include the reference or template information rather than the patient-customized information. Alternatively, the patient-customized healthcare plan/order/phase may still be carried forward in its entirety to the subsequent encounter, and an alert may be displayed informing the user that the plan/order/phase was not fully carried out as shown, thus alerting the user to investigate the situation further before ordering the healthcare plan/order/phase with respect to the subsequent encounter. In this regard, an icon or other selectable indicator may be displayed, selection of which will permit the user to view the parameters on which the previous information was calculated. Further, if the parameters on which a calculated value was obtained (e.g., weight) are known with respect to the current encounter, a calculated value may be suggested to the user. Any and all such variations, and any combination thereof, are contemplated to be within the scope of embodiments of the present invention.

In embodiments, if any of the orders associated with a selected healthcare plan/order/phase require a patient-specific calculation, for instance, a medication dosage calculation based at least in part upon the patient's weight, the calculation as it applied to the previous encounter associated with the healthcare plan/order/phase when it was ordered may or may not be carried forward, as desired or depending upon another factor. For instance, if a medication dosage was calculated based upon the patient's weight, it may be desirable to not have the patient-customized dosage from a previous encounter carried forward unless and until such time as a current weight for the patient is obtained and can be compared to the weight at which the dosage was previously calculated. In this regard, tolerances may be considered. For instance, if a current input weight is within 5% of the previous weight, the patient-customized dosage is carried forward but it is not carried forward if a variance outside of the 5% tolerance is detected or received. In another embodiment, any calculated data may not be carried forward and the reference or template information may be presented rather than the patient-customized information. In yet another embodiment, the patient-customized calculated data may still be carried forward in its entirety to the subsequent encounter, and an alert may be displayed informing the user that the calculated information needs to be verified prior to ordering. In this regard, an icon or other selectable indicator may be displayed, selection of which will permit the user to view the parameters on which the previous information was calculated. Further, if the parameters on which a calculated value was obtained (e.g., weight) are known with respect to the current encounter, a calculated value may be suggested to the user. Any and all such variations, and any combination thereof, are contemplated to be within the scope of embodiments of the present invention.

As indicated at block 226, it is then determined whether filtering of the presented healthcare plans/orders/phases is desired, as indicated at block 226. Filtering may be based on a number of different filtering criteria including, but not limited to, specified dates and/or times, presenting symptoms, conditions and/or diagnoses.

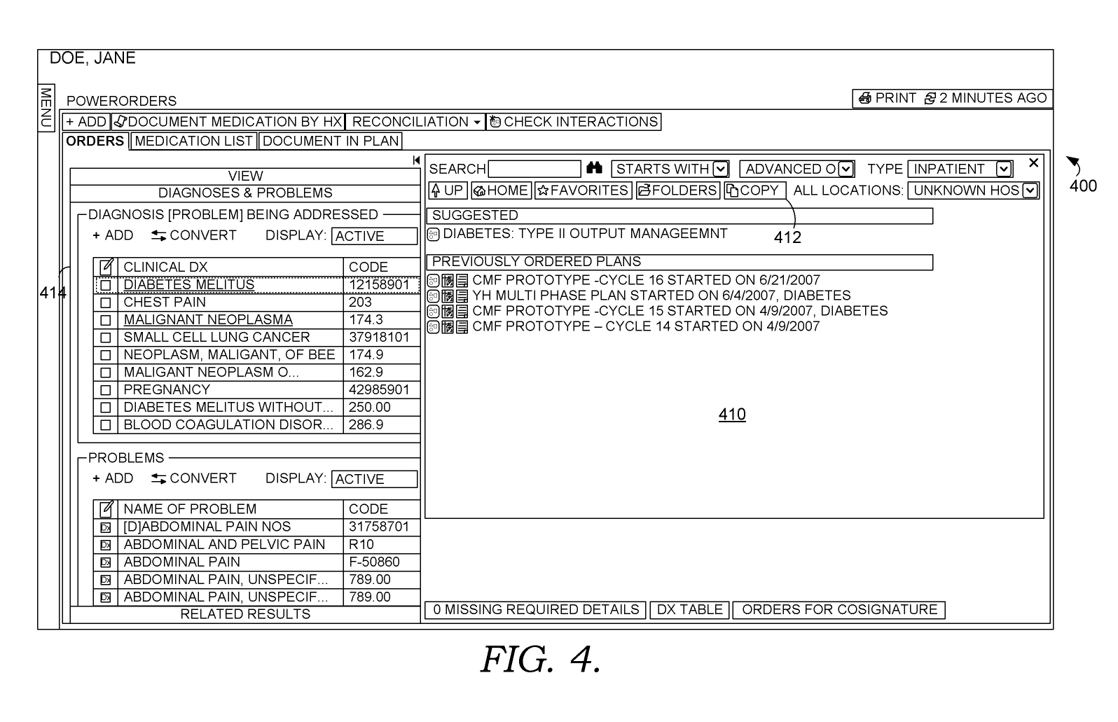

If it is determined that filtering of the presented healthcare plans/orders/phases is desired, the desired filtering criterion(ia) is received, as indicated at block 228, and the presented healthcare plans/orders/phases are filtered based upon the received filtering criterion(ia), as indicated at block 230. The filtered healthcare plans/orders/phases are then presented, as indicated at block 232. FIG. 4 is a screen display of an exemplary view 400 illustrating a manner in which a user may filter plans that have been ordered for a patient in association with at least one prior encounter based upon condition/diagnosis. Similar to view 300, the view 400 includes a content display area 410 that displays previously customized, patient-specific healthcare plans, orders, healthcare plan phases, and/or portions thereof that have been customized for a particular patient in association with a previous encounter, and a selectable copy indicator 412, selection of which permits a particular displayed and previously customized, patient-specific healthcare plan, order, healthcare plan phase, and/or portion thereof to be ordered for the particular patient in association with the subsequent encounter. The view 400 further includes a filtering criteria display area 414 that displays at least one filtering criterion on which the displayed and previously customized, patient-specific healthcare plans, orders, healthcare plan phases, and/or portions thereof may be filtered. In the illustrated view 400, the filtering criteria represent presenting symptom, conditions and/or diagnoses associated with prior encounters.

Referring back to FIG. 2A, if it is determined at block 212 that the patient has previously presented at the facility or a related facility, the second pathway the method may take is illustrated with reference to FIG. 2D. As indicated at block 234, a presenting condition and/or diagnosis indicator is received for the patient. It is then determined whether or not the patient has presented at the facility or a related facility with the same presenting condition and/or diagnosis. This is indicated at block 236. If the patient has not previously presented at the facility or a related facility with the same presenting condition and/or diagnosis, the method continues as indicated in FIG. 2C, as described herein above.

If, however, it is determined that the patient has previously presented at the facility or a related facility with the same presenting condition and/or diagnosis, healthcare plans/orders/phases ordered for the presenting patient that are associated with a previous encounter and associated with the presenting condition and/or diagnosis are presented, as indicated at block 238. Generally, at least one such previously ordered healthcare plan/order/phase includes any patient-customizations input in association with the encounter(s) to which the plan/order/phase corresponds. It is then determined whether further filtering of the presented healthcare plans/orders/phases is desired, as indicated at block 240. As previously set forth, such filtering may be based on a number of different filtering criteria including, but not limited to specified dates and/or times, presenting symptoms, conditions and/or diagnoses.

If it is determined that further filtering of the presented healthcare plans/orders/phases is desired, the desired filtering criterion(ia) is received, as indicated at block 242, and the presented healthcare plans/orders/phases are filtered based upon the received filtering criterion(ia), as indicated at block 244. The filtered healthcare plans/orders/phases are then presented, as indicated at block 246. FIG. 4 is a screen display of an exemplary view 400 illustrating a manner in which a user may filter plans that have been ordered for a patient in association with at least one prior encounter based upon condition/diagnosis.

If it is determined at either block 226 of FIG. 2C or block 240 of FIG. 2D that filtering (or further filtering, as appropriate) of the presented healthcare plans/orders/phases is not desired, or subsequent to presentation of filtered healthcare plans/orders/phases as indicated at either block 232 of FIG. 2C or block 246 of FIG. 2D, the method continues as illustrated in FIG. 2E. As indicated at block 248, a selection of a presented (and filtered, as appropriate) healthcare plan/order/phase is received. Generally, although not required, the selected healthcare plan/order/phase will include at least one patient-customization associated therewith that was made in association with a previous encounter. As previously set forth, patient customizations may include, by way of example only, the addition of an order to a healthcare plan or phase, the exclusion of an order from a healthcare plan or phase, a medication dosage calculation (generally based on patient-specific parameters such as weight), and detail changes to an order (whether or not associated with a healthcare plan or phase). Subsequently, detail associated with the selected healthcare plan/order/phase is presented, as indicated at block 250.

As indicated at block 252, it is next determined whether any (further) patient-customizations of the presented healthcare plan/order/phase are desired. If it is determined that at least one (further) patient-customization is desired, such customization(s) to the selected healthcare plan/order/phase are received, as indicated at block 254. The patient-customization(s) are then associated with the selected plan/order/phase, the patient and the current encounter, as indicated at block 256.

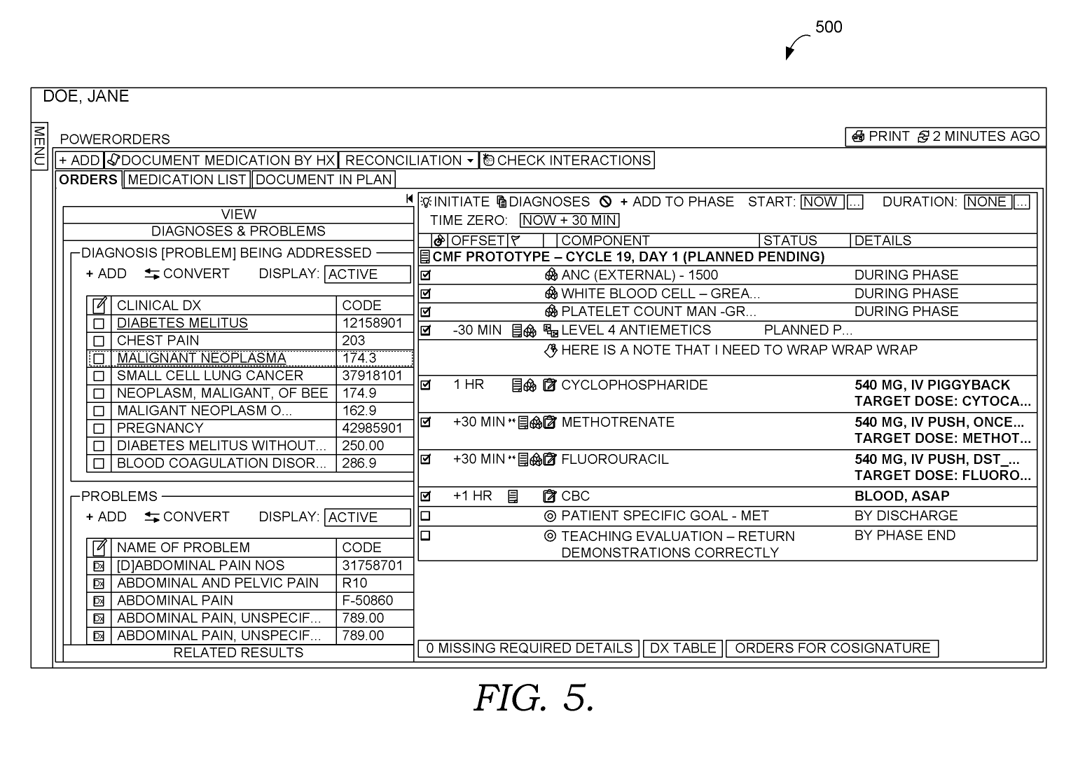

As indicated at block 258, if it is determined at block 252 that (further) patient-customizations are not desired, or subsequent to associating received customization(s) with the patient, plan/order/phase and current encounter as indicated at block 256, an indication is received to change the status of the selected and/or customized healthcare plan/order/phase from ‘orderable’ to ‘ordered’ in association with the presenting patient and the current encounter. The status of the healthcare plan/order/phase is subsequently changed to ‘ordered’ for the presenting patient, as indicated at block 260, and accordingly stored in association with an electronic medical record associated with the presenting patient, e.g., an electronic medical record generated by Cerner Millennium available from Cerner Corporation of North Kansas City Mo. FIG. 5 is a screen display of an exemplary view 500 illustrating that a healthcare plan has been copied, including the customizations made in association with the prior encounter, in accordance with an embodiment of the present invention.

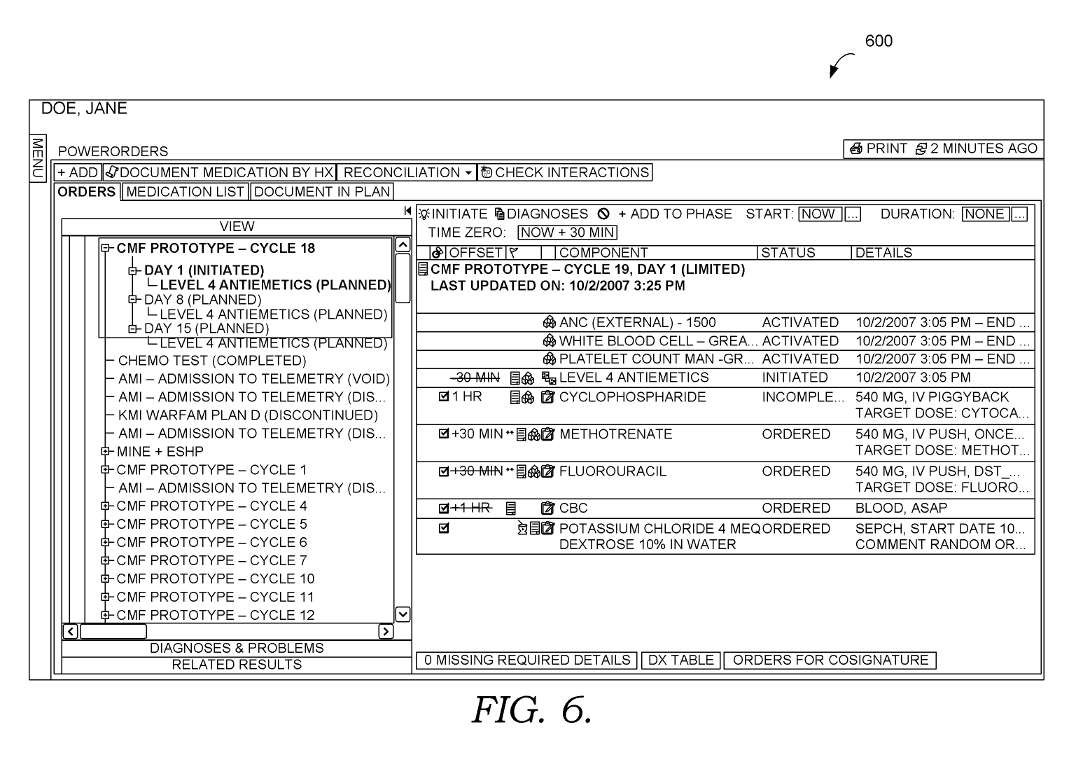

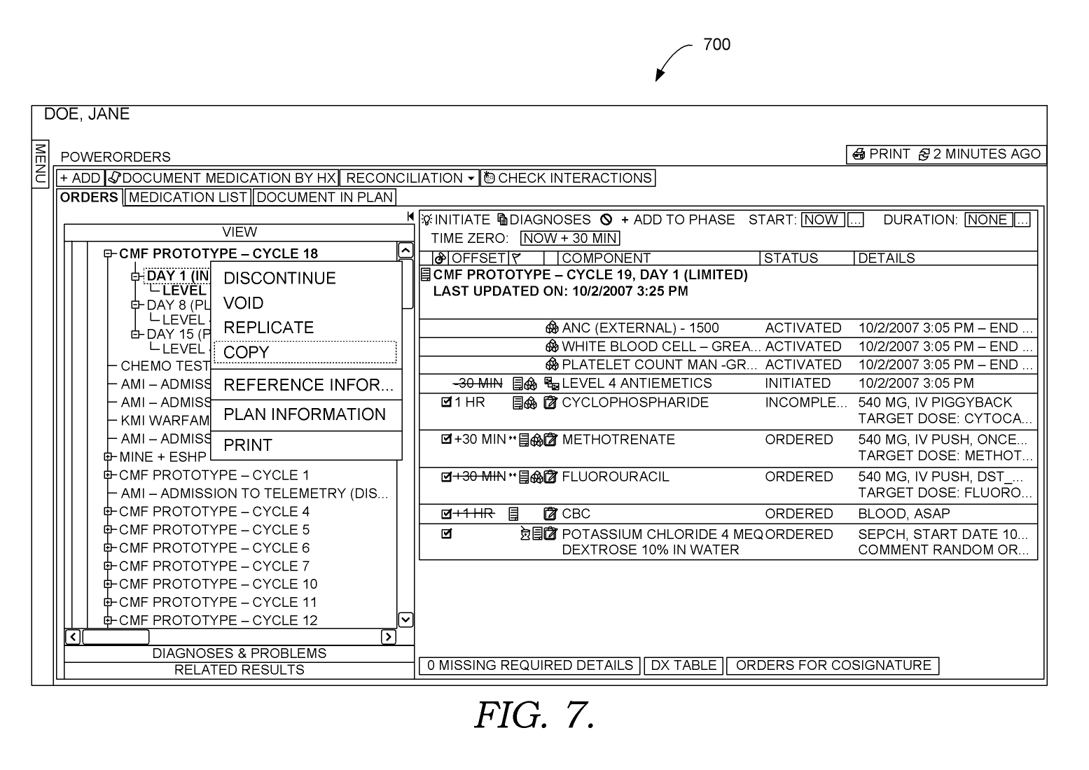

FIG. 6 is a screen display of an exemplary view 600 illustrating a healthcare plan that has been ordered for a patient and includes at least one customization made prior to ordering, in accordance with an embodiment of the present invention. In embodiments, even within the same encounter, a healthcare plan/order/phase may be copied if it is desired for the healthcare plan/order/phase to be repeated for the patient. FIG. 7 is a screen display of an exemplary view 700 illustrating a manner in which a user may copy the selected phase of the healthcare plan, including the customizations, for instance, in association with the same encounter, in accordance with an embodiment of the present invention.

As can be understood, embodiments of the present invention provide computerized methods and systems for use in, e.g., a healthcare computing environment, for copying a healthcare plan, order, phase, or portion thereof, that is associated with a first encounter for a patient and includes at least one patient-specific customization, upon the patient presenting on a second encounter having the same condition/diagnosis. Embodiments of the present invention allow healthcare plans/orders/phases customized for a specific patient to be copied forward for subsequent encounters at the same or a related facility. Embodiments permit orders included and/or excluded from a healthcare plan or phase to be similarly included and/or excluded from subsequently ordered healthcare plans or phases without the necessity for the user to customize in association with the subsequent encounter. Embodiments further permit details of an order that have been modified in association with a previous encounter to be copied to a subsequent encounter, as well as dosage calculation information and the like. Further, embodiments permit searching of a presenting patient's electronic medical record for previously ordered healthcare plans/orders/phases by, for instance, a specified date or time and/or a presenting symptom, condition or diagnosis. Embodiments reduce the clinician's time in ordering healthcare plans/orders/phases as they do not have to make the same customizations every time they want to order the same healthcare plan/order/phase for a patient on a subsequent encounter. Further, embodiments improve patient safety. For instance, if a medication dosage has been previously reduced for a patient, e.g., due to an abnormal tolerance, such reduction may be automatically carried forward to subsequent treatments.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and within the scope of the claims.

What is claimed is:

1. One or more computer-readable storage media having computer-executable instructions embodied thereon that, when executed, perform a method in a clinical computing environment for presenting previously customized, patient-specific healthcare plans, orders, phases and/or portions thereof, in association with subsequent patient encounters, the method comprising:
receiving an indicator of at least one of a condition or a diagnosis associated with a patient and a particular encounter;
determining that the patient has presented with the at least one of the condition or the diagnosis in association with at least one previous encounter; and
presenting at least one order, healthcare plan, healthcare plan phase, or portion thereof associated with the at least one previous encounter, wherein the presented at least one order, healthcare plan, healthcare plan phase, or portion thereof includes at least one customization specific to the patient.

2. The one or more computer-readable storage media of claim 1, wherein the method further comprises permitting the presented at least one order, healthcare plan, healthcare plan phase, or portion thereof to be ordered for the patient in association with the particular encounter.

3. The one or more computer-readable storage media of claim 1, wherein the at least one customization specific to the patient includes addition of an order, deletion of a reference order, or modification of a reference order detail.

4. The one or more computer-readable storage media of claim 1, wherein the at least one customization specific to the patient causes the at least one order, healthcare plan, healthcare plan phase, or portion thereof associated with the at least one previous encounter to differ from a reference order, healthcare plan, healthcare plan phase, or portion thereof associated with the at least one of the condition or the diagnosis.

5. The one or more computer-readable storage media of claim 1, wherein presenting at least one order, healthcare plan, healthcare plan phase, or portion thereof includes presenting a plurality of orders, healthcare plans, healthcare plan phases, or portions thereof, and wherein each of the plurality of orders, healthcare plans, healthcare plan phases, or portions thereof includes one or more customizations specific to the patient.

6. The one or more computer-readable storage media of claim 5, wherein the method further comprises determining that filtering of the presented plurality of orders, healthcare plans, healthcare plan phases, or portions thereof is desired.

7. The one or more computer-readable storage media of claim 6, wherein the method further comprises:
receiving at least one filtering criterion;
filtering the plurality of orders, healthcare plans, healthcare plan phases, or portions thereof utilizing the at least one filtering criterion to create a filtered set of orders, healthcare plans, healthcare plan phases, and/or portions thereof; and
presenting the filtered set of orders, healthcare plans, healthcare plan phases, and/or portions thereof.

8. The one or more computer-readable storage media of claim 7, wherein the at least one filtering criterion is a specified date, a specified time, or the condition or the diagnosis associated with the patient and the particular encounter.

9. The one or more computer-readable storage media of claim 7, wherein the method further comprises permitting the presented at least one order, healthcare plan, healthcare plan phase, or portion thereof to be ordered for the patient in association with the particular encounter.

10. The one or more computer-readable storage media of claim 1, wherein the at least one customization specific to the patient included in the presented at least one order, healthcare plan, healthcare plan phase, or portion thereof is associated with the condition or the diagnosis associated with the patient and the particular encounter.

11. One or more computer-readable storage media having computer-executable instructions embodied thereon that, when executed, perform a method in a clinical computing environment for presenting previously customized, patient-specific healthcare plans, orders, healthcare plan phases, and/or portions thereof, in association with subsequent patient encounters, the method comprising:
receiving a first indicator of at least one of a symptom, a condition or a diagnosis associated with a patient and a particular encounter, the particular encounter being associated with a facility;
determining that the patient has not previously presented with the at least one of the symptom, the condition, or the diagnosis at the facility or a related facility;
presenting at least one reference order, healthcare plan, healthcare plan phase, or portion thereof that is related to the at least one of the symptom, the condition, or the diagnosis;
receiving at least one customization to a selected one of the at least one reference order, healthcare plan, healthcare plan phase, or portion thereof, the at least one customization being specific to the patient, to create a customized order, healthcare plan, healthcare plan phase, or portion thereof;
storing the customized order, healthcare plan, healthcare plan phase, or portion thereof in association with the patient;
receiving a second indicator of the at least one of the symptom, the condition, or the diagnosis associated with the patient and a subsequent encounter, the subsequent encounter being associated with the facility or a facility related thereto; and
presenting the customized order, healthcare plan, healthcare plan phase, or portion thereof.

12. The one or more computer-readable storage media of claim 11, wherein the method further comprises permitting the customized order, healthcare plan, healthcare plan phase, or portion thereof to be ordered for the patient in association with the subsequent encounter.

13. The one or more computer-readable storage media of claim 1, wherein the at least one customization includes addition of an order, deletion of a reference order, or modification of a reference order detail.

14. The one or more computer-readable storage media of claim 11, wherein the at least one customization causes the customized order, healthcare plan, healthcare plan phase, or portion thereof to differ from the selected one of the at least one reference order, healthcare plan, healthcare plan phase, or portion thereof.

15. The one or more computer-readable storage media of claim 1, wherein presenting the customized order, healthcare plan, healthcare plan phase, or portion thereof includes presenting a plurality of customized orders, healthcare plans, healthcare plan phases, or portions thereof, and wherein each of the plurality of customized orders, healthcare plans, healthcare plan phases, or portions thereof includes one or more customizations specific to the patient.

16. The one or more computer-readable storage media of claim 15, wherein the method further comprises determining that filtering of the presented plurality of customized orders, healthcare plans, healthcare plan phases, or portions thereof is desired.

17. The one or more computer-readable storage media of claim 16, wherein the method further comprises:
receiving at least one filtering criterion;
filtering the plurality of customized orders, healthcare plans, healthcare plan phases, or portions thereof utilizing the at least one filtering criterion to create a filtered set of customized orders, healthcare plans, healthcare plan phases, and/or portions thereof; and
presenting the filtered set of customized orders, healthcare plans, healthcare plan phases, and/or portions thereof.

18. The one or more computer-readable storage media of claim 17, wherein the at least one filtering criterion is a specified date, a specified time, or the symptom, the condition or the diagnosis associated with the patient and the particular encounter.

19. One or more computer-readable storage media having computer-executable instructions embodied thereon that, when executed, cause display of a user interface that presents previously customized, patient-specific healthcare plans, orders, healthcare plan phases, and/or portions thereof, in association with subsequent patient encounters, the user interface comprising:
a content display area that displays previously customized, patient-specific healthcare plans, orders, healthcare plan phases, and/or portions thereof that have been customized for a particular patient in association with a previous encounter, such display occurring upon the particular patient presenting in association with a subsequent encounter at a facility associated with the previous encounter or a facility related thereto with at least one of a symptom, a condition, or a diagnosis related to the previous encounter; and
a selectable copy indicator, selection of which permits a particular displayed and previously customized, patient-specific healthcare plan, order, healthcare plan phase, and/or portion thereof to be ordered for the particular patient in association with the subsequent encounter.

20. The one or more computer-readable storage media of claim 19, wherein the user interface further comprises a filtering criteria display area that displays at least one filtering criterion on which the displayed and previously customized, patient-specific healthcare plans, orders, healthcare plan phases, and/or portions thereof may be filtered.
